(19) United States
(12) Patent Application Publication
(10) Pub. No.: US 2015/0146239 A1
(43) Pub. Date: May 28, 2015

(54) Comparing Planned and Actual Asset Locations

(71) Applicant: Lexmark International, Inc., Lexington, KY (US)

(72) Inventors: John Douglas Anderson, Lexington, KY (US); Brent Allen Schanding, Winchester, KY (US); Forrest Lane Steely, Lexington, KY (US)

(73) Assignee: Lexmark International, Inc., Lexington, KY (US)

(21) Appl. No.: 14/088,548

(22) Filed: Nov. 25, 2013

(51) Int. Cl. G01S 5/02; H04W 4/02; G01S 5/00

(52) U.S. Cl. CPC G01S 5/0284; G01S 5/009; H04W 4/021
USPC 358/1.15

(57) ABSTRACT

A computing device display shows an actual location of an imaging device as configured in a computing system environment. An acceptance zone about a planned location of the imaging device visually conveys to a user whether or not the imaging device exists within a predetermined distance. If not, service level or other agreements specifying the location of the imaging device can be adjusted or the imaging device can be moved into compliance with the agreements. Alerts can be broadcast upon non-compliance or if the imaging device changes location. The display can be configured to show the imaging device with geospatial coordinates, within a building, superimposed on a map, such as a building floor plan, etc. Other embodiments note computing environments, deltas between locations, and various administrative tools.

### FIELD OF THE DISCLOSURE

The present disclosure relates to asset management and comparing planned asset locations to actual locations to verify compliance and whereabouts. Methods and apparatus facilitate visual comparison between the locations. Imaging devices in a computing environment typify the form of the assets.

### BACKGROUND

Locating systems are known for tracking assets. Computing devices determine the existence, whereabouts and timing of items being transported, stored and deployed for use. Items are tracked in static environments, such as stores and warehouses, for control of inventory and in dynamic environments involving complex positioning of cars, trucks, planes, etc. moving unconstrained around the globe. Items are enrolled for tracking into asset management systems by technicians who identify the assets and who provide their initial positions. The technicians determine positions from “location aware” devices with GPS (global positioning system) electronics and/or manual computations derived from maps and floor plans of buildings, campuses, etc. Assets may also “self enroll” in environments having multiple point sources that triangulate positions by way of transponders attached to the assets.

Unfortunately, technicians sometimes put assets in the wrong places and GPS electronics are known to function poorly in concrete laden city environments. Even when working properly, and calibrated within a traditional twenty-five foot radius, technicians sometimes use GPS devices to install assets on the wrong sides of walls, in wrong offices and on wrong floors and cannot cross-reference their position as they often do not have reliable maps, floor plans, office layouts, etc. Sometimes users will move assets from one place to a next since they do not care for their initial placement by technicians, but yet provide no notice to parties regarding movement. As an increasing number of customers contract vendors to manage, service, or otherwise maintain their assets, vendors must at all times reliably know the precise locations of assets-under-management. Clearly, a need exists in the art to better know the whereabouts of assets.

When assets-under-management include imaging devices (e.g., printers, copiers, multi-function devices, etc.) enrolled in a managed print services (MPS) environment, for example, printer manufacturers, suppliers, etc. are responsible for monitoring fleets of imaging devices to know printing volumes, paper and ink/toner levels, readiness, working conditions, and the like. By knowing the status of each imaging device, manufacturers and suppliers can respond to customers needs by generating automatic orders to replace near-empty supply items and sending personnel to imaging devices requiring service upon the detection of malfunctions. They can also provide scheduled calls by technicians under the terms of the MPS contract or under service-related clauses of separate Service Level Agreements (SLAs).

As is typical, SLAs establish physical zones or regions of maintenance in buildings, sectors, floors, etc. of an enterprise and imaging devices receive one level of maintenance, guarantees of readiness (“up times”), etc., while imaging devices found outside the zones receive other levels of maintenance/guarantees. Sometimes the SLAs structure the imaging devices in different zones to receive the same exact maintenance and service, but at different times of the year. While precise knowledge of initial locations of imaging devices and tracking their movement is important, SLAs spotlight this importance as it is to critical to know whether or not imaging devices are located within their planned maintenance zones. Knowing it minimizes the time required for technicians to deliver services, while not knowing it wastes time in searching for devices and keeps devices in an unready condition. While SLA contracting parties attempt to track placement and movement of imaging devices by way of entries in a database, entries become inaccurate as soon as users move devices from one position to a next without notifying the MPS vendor and/or upon failure to update the database in light of the movement. What is further needed, therefore, is a simple technique to define an asset's location within a tracking environment relative to a service contract relating to it, especially involving situations having planned asset locations/zones. Additional benefits and alternatives are also sought when devising solutions.

### SUMMARY

The above-mentioned and other problems become solved by methods and apparatus that facilitate comparison between planned asset locations and actual locations to verify whereabouts and compliance with contracts, for example. In a representative embodiment, a computing display shows a present location of an imaging device as configured in a computing system environment. An acceptance zone about a proposed location of the imaging device visually conveys to the user whether or not the present location exists within a predetermined area. If not, service level agreements or other contracts specifying the location of the imaging device can be adjusted to accommodate the new location or the imaging device can be moved into the zone to comply with the terms of the agreements. Alerts can be broadcast if the imaging device is not in compliance or if its location changes. The display can be further configured to show the imaging device with geospatial coordinates, within a building, and/or superimposed on a map, such as a building floor plan. In this way, users can make visual comparisons that afford quick and easy determinations regarding the compliance of assets within their proposed locations. Other embodiments note computing environments, calculating deltas between locations, and arranging assets for visualization. Software, executable code, interfaces, and mobile applications typify the embodiments.

In other embodiments, an asset management system includes a database containing attributes of the assets enrolled in the system. The attributes include unique identifiers such as make, model number, and serial number of the assets, as well as other attributes such as location. The asset management system includes a visualization tool allowing the asset to be seen on a map, and depending on zoom level, on a building floor plan as well. The tool also allows different “layers” of the map to be displayed, wherein layers show different attributes of the floor plan. The invention further proposes to include the planned location of the assets relative to the floor plan, which can be selectively viewed by users and/or vendors. The management system also provides for the generation of reports and sending alerts. Enrollment of assets into the system is made easier for technicians as they are able to view planned locations of assets to determine if they correspond to one of the locations shown on the floor plan layer of proposed asset locations.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a computing system environment having assets in the form of imaging devices.

FIG. 2 is a diagrammatic view for readily comparing planned asset locations to actual locations, including computing environments and displays for an asset management system.

FIG. 3 is a diagrammatic view showing alternate embodiments for comparing planned locations to actual locations of assets, including determining locations of assets.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, methods and apparatus facilitate comparisons between planned and actual locations of assets to verify whereabouts and compliance with contracts, for example.

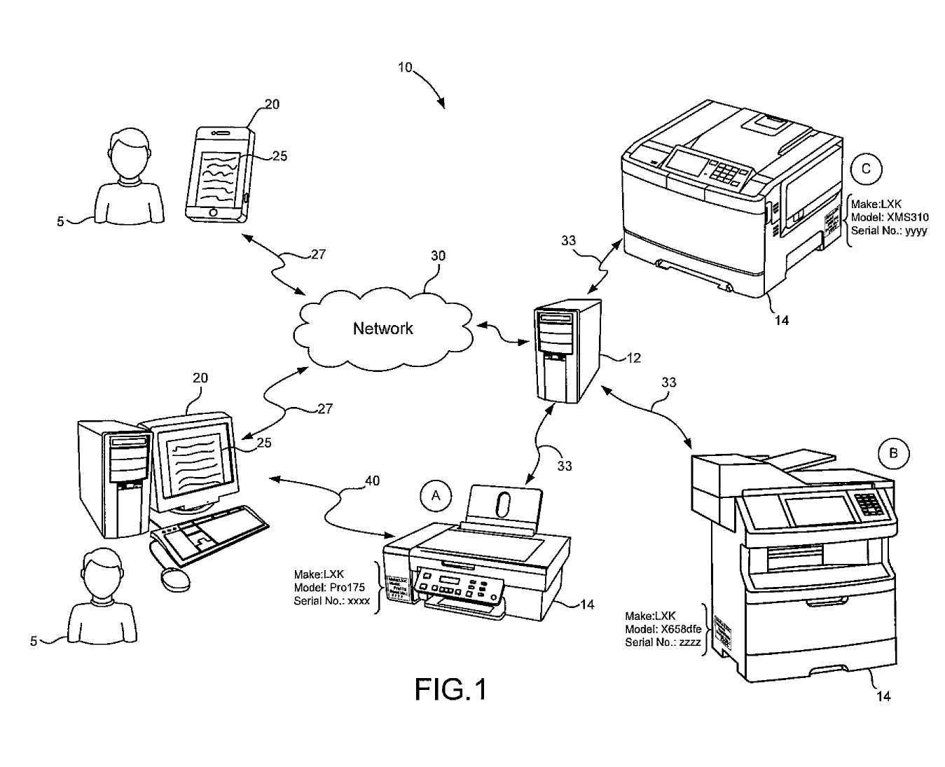

With reference to FIG. 1, a computing environment 10 includes computing devices 20 such as smart phones, laptops, desktops, tablets, etc. and imaging devices 14 such as printers, copiers, fax machines, multi-function printers (MFPs) etc. Users 5 interact with their devices 20 to engage items 25 such as documents, images, web pages, screen shots, messages, files, photos, etc. They request imaging of the items by sending a “print job” direct 40 to a connected imaging device 14-A or indirect 27 by way of a print server 12 and attendant computing network 30, as is known.

Under a managed print services (MPS) contract or service level agreement (SLA), for example, the imaging devices 14 are configured in the computing environment for an enterprise. Terms of the contracts vary but often specify where imaging devices are to be located, what levels of service they will receive, and define terms of readiness. Examples include, but are not limited to, “imaging devices located in the warehouse will have service technicians physically examine and clean/repair the devices at least once per month” and “imaging devices will have 95% ‘up time’ per every month.” During installation of the imaging devices under the contracts, technicians ensure the proper physical placement of all devices and enroll them into an asset management system. They enter the make, model and serial number of each device as well as their initial locations. Over time, however, the devices migrate from one location to a next and their new locations may or may not fall under the original terms of the contract which requires technicians to spend extra time finding them before providing service.

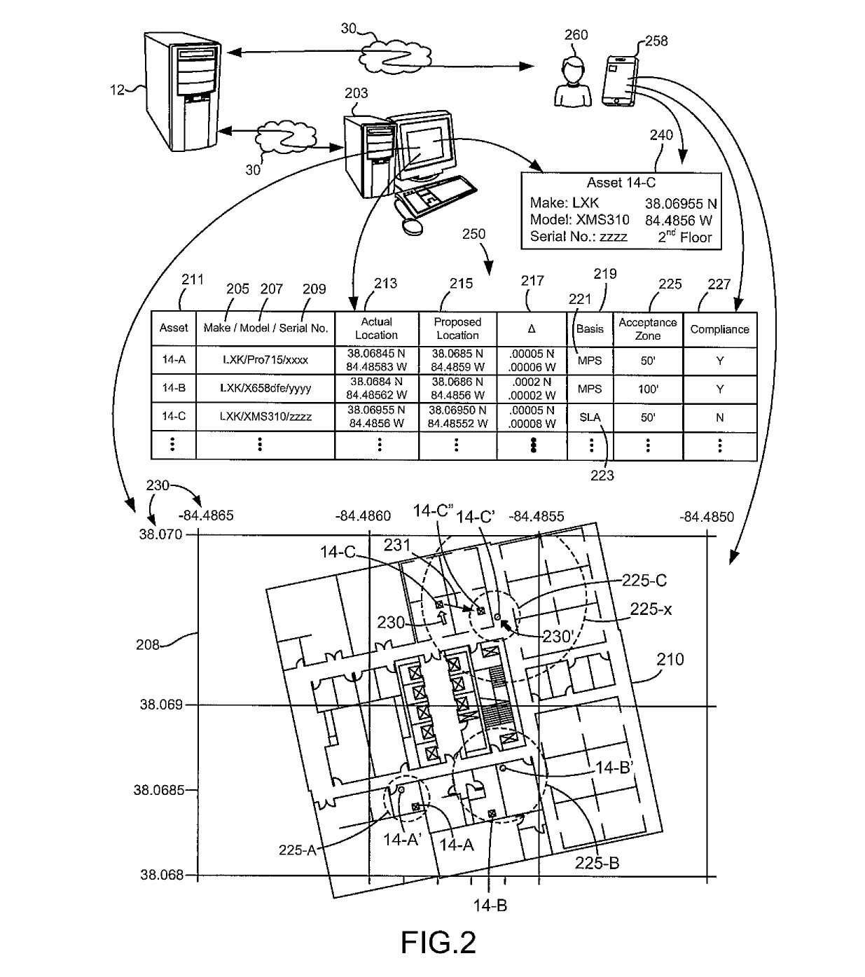

To counter this, FIG. 2 shows a computing environment 200 facilitating the ready comparison of an asset's planned location to its actual location. As seen, a computing device 203 includes an asset management system 250 containing attributes of assets enrolled in the system. The attributes include unique identifiers such as make 205, model number 207, and serial number 209 of each asset 211, as well as other attributes such as location. The location is divided into an actual location 213 of the asset as the asset is presently positioned somewhere in an environment and its planned location 215, as well as any delta 217 between the two locations. The delta can be defined in distance measurements in a variety of schemes (X-Y-Z coordinates, r/theta, vector math, latitude/longitude corrections, or other). As the planned location derives its basis in fact from a contract, such as an MPS contract or SLA, the asset management system further notes the basis 219 of the planned location and, perhaps, attaches the MPS or SLA document at 221, 223. As agreed upon between users of the asset and, perhaps, a vendor of the asset, the actual location 213 of the asset can vary (delta, 217) from the planned location 214 by a predetermined amount. This amount can be measured in feet, in geospatial coordinates, by proximity to other known items, etc. and, however measured, is provided at 225 in terms of an acceptance zone relative to the planned location. Upon comparison of the actual location of the asset to its planned location, compliance or not (Y or N) can be noted at 227.

The asset management system 250 also includes a visualization tool allowing the entries of the asset in the system to be visualized, say on a map 208, including or not a floor plan 210. In referencing geospatial coordinates 230, the asset's whereabouts can be precisely noted on the map. By superimposing on the map the acceptance zone 225 about the proposed locations for each of the assets labeled 14-A′, 14-B′ and 14-C′, for example, users of the map can readily discern whether or not the actual locations of the asset 14-A, 14-B and 14-C fall therein. If not, compliance of the asset with its underlying contract, e.g., MPS, SLA, can be quickly discerned. In the example given, asset 14-C is not within its acceptance zone 225-C, while each of assets 14-A and 14-B are within their acceptance zones 225-A, 225-B. Thus, asset 14-C does not comply (N) at 227 with its SLA contract at 223, while assets 14-A and 14-B do comply (Y) with their MPS contracts at 221. In order to now get asset 14-C into compliance, the asset can be relocated from its actual location and physically moved at action arrow 231 to the location at 14-C″ within the acceptance zone 225-C or the terms of the acceptance zone can be enlarged such that the basis of the SLA is altered at 225-x to include the present location of the asset 14-C. Of course, the latter further dictates updating the asset management system to reflect the change of the size of the acceptance zone. The visualization tool is configured to easily allow enlarging/shrinking the acceptance zone as well as moving the locations of the assets, such as by hook/drag, tap and doubletap, etc. or by other techniques of a computing nature. Hovering, clicking, etc. the cursor 230, 230′ at or near the locations of the asset or the acceptance zone allows visualization tools, such as boxes 240, to be generated on the display of the computing device in which the attributes of the asset or the zone are revealed to the user.

A smart phone 258 or other handheld device of the technician 260 is equally outfitted with the asset management system so the technician can easily find the imaging devices for servicing, enrollment into the system, and movement to get them into compliance with their contractual or other basis 219. (U.S. patent applications Ser. Nos. 13/853,573 and 13/853,591, entitled ‘Initial Calibration of Asset-to-be-Tracked,’ both filed Mar. 29, 2013 provide further detail on initial enrollment of assets into an asset management system and are incorporated herein by reference. Enrollment of assets into the system is now made easier for technicians as they are able to view planned locations of assets to determine if they correspond to one of the locations shown on the floor plan layer of proposed asset locations.) Either or both of the computing device 203 and smart phone 258 are able to communicate with still other computing devices in the computing environment over the network 30, such as a server like server 12 of the imaging environment of FIG. 1. The asset management system 250 can be further installed in whole or in part on this server or still other computing devices.

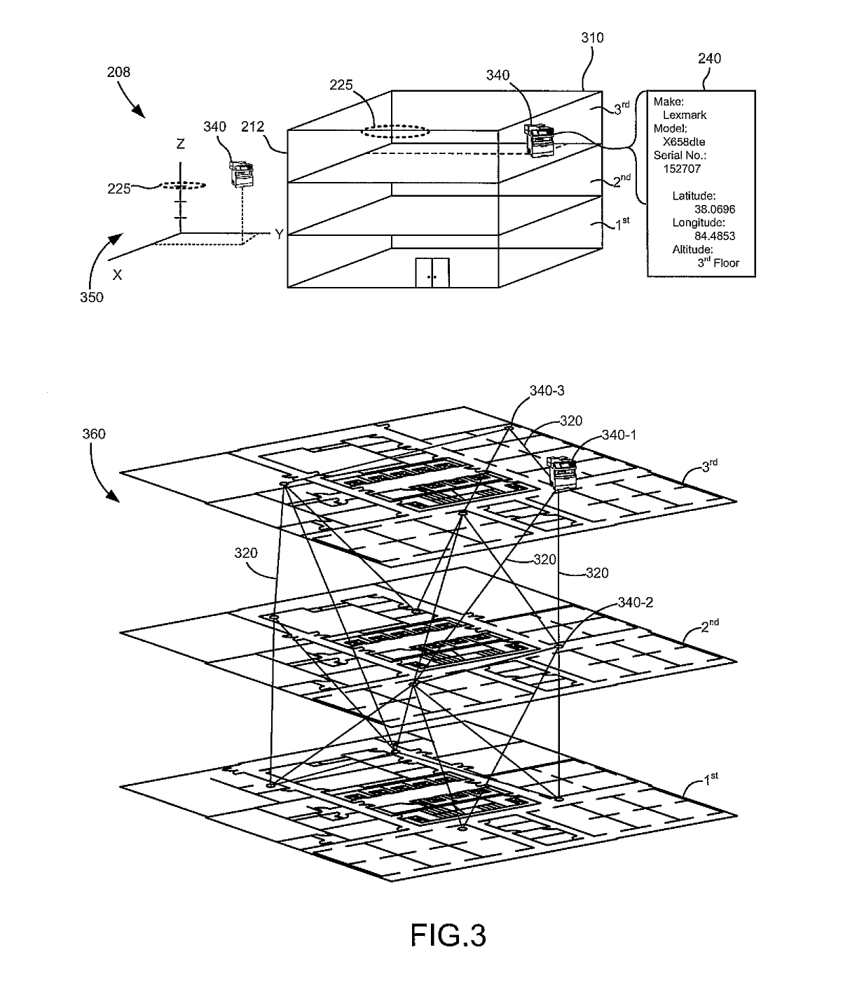

With reference to FIG. 3, the visualization tool is configured to allow users other means of readily discerning compliance between an asset's planned location and its actual location. On the displayed map 208, and depending on ‘zoom level,’ the user/vendor/etc. can view assets 340 on a building view 310, on a view showing a coordinate system 350, or floor plans 360 abstracted as floors 1^{st}, 2^{nd}, 3^{rd} as they would exist in the building. Acceptance zones 225 for the asset 340 can be superimposed on the views to ascertain ready compliance of the asset's planned location versus its actual location. The X-Y plane denotes a coordinate plane such as latitude and longitude, while the Z-direction notes an altitude or height of the asset above the ground level (AGL). The height can be measured in actual distance from a base of the building, say twenty feet, but can also represent a number of floors, say 3^{rd} floor, of a building. It can also reflect a height relative to another baseline, such as mean sea level (MSL) based on barometric pressure, or can be an estimate of height noted by the technician.

The asset management system is further configured for the generation of reports and sending alerts. Reports can take the form of hard copy printouts of views displayed on computing devices, such as maps or entries of attributes found in the system, or reports indicating compliance or not of an asset relative to a contract and its basis for compliance or not. Alerts can take the form of emails and texts to users, pop-ups on the asset management system, or the like. The alerts are especially useful upon the asset being moved from one location to a next and/or to provide notice that an asset's actual location is or is not in compliance with its planned location.

When determining the actual location of an asset's whereabouts, a variety of techniques are presented. With reference to all Figures, floor plans 210 are calibrated with geospatial coordinates, such as those associated latitude and longitude pairs and/or altitude (for multi-story buildings). Relative locations can be noted by “pin drops” or other designators such as flags, stars, etc. placed on maps from the mapping function of the smart phone 258. Universal Transverse Mercator (UTM) coordinates are still other styles of geospatially noting coordinates. Handheld GPS devices of a technician are used to establish the coordinates or they are obtained by surveying the site, by satellite mapping, or by other techniques. In turn, assets in the form of imaging devices are configured with radio devices, such as radio transceivers or transponders. After installation, the radio devices randomly or periodically transmit identifying radio signals 320 from one imaging device 340-1 to a next 340-2, 340-3 which produces distance measurements between assets. A radio device in a first imaging device 340-1 performs ranging calculations to accurately determine the distance between itself and a radio device in a second imaging device 340-2, 340-3 using the information extracted from response signals. Calculations include, but are not limited to, RSSI (Received Signal Strength Indicator), TOA (Time of Arrival), TDOA (Time Delay of Arrival), TOF (Time of Flight), RTT (Round Trip Time), and SDS-TWR (Symmetrical Double Sided Two Way Ranging). By coordinating amongst themselves, with a central server and/or other computing device, the exact whereabouts of the assets in the environment and their locations relative to other assets are known. Movement of an asset from one location to a next location is also known by way of radio trilateration between the assets. By incorporation by reference to pending U.S. patent application Ser. No. 14/040,811, filed Sep. 30, 2013, entitled “Systems and Methods for Location-Aware Imaging Devices,” further details of the ranging, detection of movement, and placement of assets is made known.

Relative advantages of the many embodiments should now be apparent to skilled artisans. They include but are not limited to: (1) providing a quick discernment tool for determining whether an asset resides or not in its intended location; (2) providing a visualization tool for comparing an asset's planned location to its actual location; (3) providing a visualization tool that is selectively viewable; and (4) providing techniques to visually establish assets in a common arrangement, but defining each asset according to its own relationship with a party as assets under management in a fleet of assets fall under diverse service agreements.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A method of comparing a planned location of an imaging device to an actual location of the imaging device as installed in a computing system environment, comprising:
determining the actual location of the imaging device in the computing system environment;
generating a map on a computing device display showing the actual location of the imaging device;
showing on said map the planned location of the imaging device; and
providing on the computing device display a basis for the planned location of the imaging device so that compliance can be determined regarding whether the actual location of the imaging device falls within the basis for the planned location.

2. The method of claim 1, further including determining whether said compliance is achieved.

3. The method of claim 1, further including calculating a delta between the actual location and the planned location.

4. The method of claim 1, wherein the determining the actual location of the imaging device includes determining a geospatial coordinate for the imaging device.

5. The method of claim 1, further including displaying an acceptance zone on the map about the planned location of the imaging device in which the actual location of the imaging device can be found to be in said compliance or not.

6. The method of claim 1, wherein the generating the map on the computing device display further includes showing a floor plan of a building in which the imaging device is installed.

7. The method of claim 3, further including determining said compliance to see if the actual location of the imaging device exists in a distance less than the calculated delta.

8. The method of claim 1, further including broadcasting an alert if the actual location of the imaging device falls outside the basis for the planned location of the imaging device.

9. The method of claim 1, further including detecting movement of the imaging device from the actual location to a second location.

10. The method of claim 9, further including determining compliance whether the second location of the imaging device falls within the basis for the planned location of the imaging device.

11. The method of claim 1, further including adjusting the basis for the planned location of the imaging device.

12. A method for allowing visual comparison of a planned location of an imaging device to an actual location of the imaging device as configured in a computing system environment, comprising:
determining the actual location of the imaging device in the computing system environment;
showing the actual location of the imaging device on a computing device display; and
showing an acceptance zone about the planned location of the imaging device in which the actual location of the imaging device can be found or not to be in compliance within a predetermined distance of the planned location.

13. The method of claim 12, further including providing on the computing device display a basis for the planned location of the imaging device so that said compliance can be determined or not.

14. The method of claim 12, further including showing on the computing device display the planned location of the imaging device.

15. The method of claim 14, further including showing a map on the computing device display, the map showing both the actual location and the planned location.

16. The method of claim 15, further including showing a floor plan of a building in which the imaging device is configured.

17. The method of claim 12, further including broadcasting an alert if the actual location of the imaging device falls outside the acceptance zone.

18. The method of claim 12, further including detecting movement of the imaging device from the actual location to a second location and determining whether the second location of the imaging device falls within or not the acceptance zone.

19. The method of claim 12, further including calculating a delta between the actual location of the imaging device and the planned location of the imaging device and showing the delta on the computing device display.

20. A method of allowing visual comparison of a proposed location of an imaging device to an actual location of the imaging device in a building as configured in a computing system environment, comprising:
generating for a user on a computing device display a geospatial location of the actual location of the imaging device in the building; and
generating for the user on the computing device display whether the actual location of the imaging device falls within or not an acceptance zone about the proposed location of the imaging device in the building.
